(19) United States
(12) Patent Application Publication
(10) Pub. No.: US 2025/0156300 A1
(43) Pub. Date: May 15, 2025

(54) Confusion Matrix Estimation in Distributed Computation Environments

(71) Applicant: Google LLC, Mountain View, CA (US)

(72) Inventors: Jiayu Peng, Sunnyvale, CA (US); Raimundo Mirisola, Los Angeles, CA (US); Evgeny Skvortsov, Kirkland, WA (US)

(21) Appl. No.: 18/835,683

(22) PCT Filed: Dec. 4, 2023
(86) PCT No.: PCT/US2023/082282

§ 371 Date: Aug. 2, 2024

Related U.S. Application Data
(60) Provisional application No. 63/430,296, filed on Dec. 5, 2022.

(51) Int. Cl. G06F 11/34; G06F 16/22

(52) U.S. Cl. CPC G06F 11/3452; G06F 16/2255

(57) ABSTRACT

An example method includes: serving content to a plurality of client devices associated with a plurality of tag values; predicting, using a prediction system, a plurality of attributes respectively associated with the plurality of tag values; generating a data sketch descriptive of the plurality of predicted attributes; noising the data sketch, wherein the noised data sketch satisfies a differential privacy criterion; transmitting the noised data sketch to a reference system; and receiving, from the reference system, estimated performance data associated with the predicted attributes, wherein the estimated performance data is based on an evaluation of: reference attribute data associated with one or more of the plurality of tag values and the predicted attributes for the one or more of the plurality of tag values.

### PRIORITY

This application claims priority to and the benefit of U.S. Provisional Patent Application No. 63/430,296 (filed Dec. 5, 2022). U.S. Provisional Patent Application No. 63/430,296 is hereby incorporated by reference herein in its entirety.

### FIELD

The present disclosure relates generally to estimation of performance metrics for prediction systems in distributed computing environments.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

Computing and data analysis systems can generate predictions over large populations of interactions with various devices. Without access to ground truth information from the devices to evaluate the quality of the predictions, it can be difficult to optimize such predictions. Information from each device can include private or protected information and directly obtaining such information from each device can be impossible or impractical.

### SUMMARY

Aspects and advantages of embodiments of the present disclosure will be set forth in part in the following description, or can be learned from the description, or can be learned through practice of the embodiments.

Example aspects of the present disclosure provide a first example method. In some implementations, the first example method can include serving content to a plurality of client devices associated with a plurality of tag values. In some implementations, the first example method can include predicting, using a prediction system, a plurality of attributes respectively associated with the plurality of tag values. In some implementations, the first example method can include generating a data sketch descriptive of the plurality of predicted attributes. In some implementations, the first example method can include noising the data sketch, wherein the noised data sketch satisfies a differential privacy criterion. In some implementations, the first example method can include transmitting the noised data sketch to a reference system. In some implementations, the first example method can include receiving, from the reference system, estimated performance data associated with the predicted attributes, wherein the estimated performance data is based on an evaluation of: reference attribute data associated with one or more of the plurality of tag values and the predicted attributes for the one or more of the plurality of tag values.

In some implementations of the first example method, the estimated performance data comprises an updated distribution over the plurality of attributes.

In some implementations of the first example method, the estimated performance data is based on a confusion matrix estimated by the reference system.

In some implementations of the first example method, generating the data sketch comprises, for each predicted attribute: hashing a tag value associated with the predicted attribute; indexing, based on the hashed tag value, an array of the data sketch to obtain a selected position; and incrementing a value in the selected position.

In some implementations of the first example method, generating the data sketch comprises generating a plurality of data sketches respectively corresponding to a plurality of different prediction classes.

In some implementations of the first example method, noising the data sketch comprises injecting additive noise to elements of the data sketch.

In some implementations of the first example method, generating the data sketch comprises expanding an initial sketch vector into a binary representation.

In some implementations of the first example method, expanding the initial sketch comprises, for each respective predicted attribute, generating a binary vector for each frequency level, wherein the frequency level indicates a frequency with which a corresponding respective tag value is associated with the respective predicted attribute.

In some implementations of the first example method, noising the data sketch comprises randomly performing bitflips on elements of the data sketch.

In some implementations of the first example method, the data sketch comprises a count-based array.

In some implementations of the first example method, the data sketch comprises a bloom filter.

In some implementations of the first example method, the data sketch is generated with a mapping function, and wherein the reference system uses the mapping function to identify the predicted attributes associated with the one or more of the plurality of tag values.

In some implementations of the first example method, the reference system processes tag values corresponding to the reference attribute data using the mapping function to find target positions in the data sketch to which the tag values are mapped.

In some implementations of the first example method, the reference system sums values of the noised sketch stored in the target positions.

In some implementations of the first example method, the sum of the values of the noised sketch stored in the target positions corresponds to a quantity of predictions having a true attribute determined by the reference attribute data and a predicted attribute determined by a prediction class with which the noised sketch is associated.

In some implementations of the first example method, the reference system counts a number of ones in each respective binary vector of a plurality of binary vectors and scales each respective count value using a frequency associated with the respective binary vector.

In some implementations of the first example method, the reference system adjusts a count of the number of ones based on a bitflip probability.

In some implementations of the first example method, the reference system has access to ground truth tag value data for associating reference attribute data with the one or more of the plurality of tag values.

Example aspects of the present disclosure provide a second example method. The second example method can include receiving, by a reference system, a noised data sketch from a prediction system that describes a plurality of predicted attributes for a first plurality of tag values. The second example method can include obtaining reference attribute data associated with a second plurality of tag values, wherein the second plurality of tag values is a subset of the first plurality of tag values. The second example method can include computing a reference mapping of reference attribute data to identify positions in the noised data sketch associated with the second plurality of tag values. The second example method can include retrieving values from the identified position. The second example method can include evaluating, based on the retrieved values, predicted attributes associated with the second plurality of tag values. The second example method can include generating estimated performance data associated with the predicted attributes.

In some implementations of the second example method, the estimated performance data comprises an updated distribution over the plurality of attributes.

In some implementations of the second example method, the estimated performance data is based on a confusion matrix estimated by the reference system.

In some implementations of the second example method, the second example method includes summing values of the noised sketch stored in the positions.

In some implementations of the second example method, the sum of the values of the noised sketch stored in the positions corresponds to a quantity of predictions having a true attribute determined by the reference attribute data and a predicted attribute determined by a prediction class with which the noised sketch is associated.

In some implementations of the second example method, the second example method includes counting a number of ones in each respective binary vector of a plurality of binary vectors; and scaling each respective count value using a frequency associated with the respective binary vector.

In some implementations of the second example method, the second example method includes adjusting a count of the number of ones based on a bitflip probability.

In some implementations of the first example method or the second example method, the reference system generates an estimated confusion matrix descriptive of predictions across a plurality of prediction systems.

In some implementations of the first example method or the second example method, the reference system has access to ground truth tag value data for associating reference attribute data with the one or more of the plurality of tag values.

Example aspects of the present disclosure provide one or more example non-transitory computer-readable media storing instructions that are executable by one or more processors to cause a computing system to perform example operations. In some implementations, the example operations can include any of the implementations of the first example method or the second example method.

Example aspects of the present disclosure provide an example computing system that includes one or more processors and one or more example non-transitory computer-readable media storing instructions that are executable by one or more processors to cause a computing system to perform example operations. In some implementations, the example operations can include any of the implementations of the first example method or the second example method.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system for estimating performance metrics according to example implementations of aspects of the present disclosure.

FIG. 2 is a flow chart diagram illustrating an example method for estimating performance metrics according to example implementations of aspects of the present disclosure.

FIG. 3 is a flow chart diagram illustrating an example method for estimating performance metrics according to example implementations of aspects of the present disclosure.

FIG. 4 is a flow chart diagram illustrating an example method for training a machine-learned model according to example implementations of aspects of the present disclosure.

FIG. 5 is a block diagram of an example processing flow for using machine-learned model(s) to process input(s) to generate output(s) according to example implementations of aspects of the present disclosure.

FIG. 6 is a block diagram of an example model development platform according to example implementations of aspects of the present disclosure.

FIG. 7 is a block diagram of an example training workflow for training a machine-learned model according to example implementations of aspects of the present disclosure.

FIG. 8 is a block diagram of an inference system for operating one or more machine-learned model(s) to perform inference according to example implementations of aspects of the present disclosure.

FIG. 9 is a block diagram of an example networked computing system according to example implementations of aspects of the present disclosure.

FIG. 10 is a block diagram of an example computing device according to example implementations of aspects of the present disclosure.

FIG. 11 is a block diagram of an example computing device according to example implementations of aspects of the present disclosure.

### DETAILED DESCRIPTION

Generally, the present disclosure is directed to systems and techniques for secure and private multi-party computations. In some example implementations of the present disclosure, a content provider system can serve content at scale to a number of devices. The number of devices can be associated with various characteristics. The content provider system can predict various performance metrics associated with serving the content to the devices, such as predicting the various characteristics associated with the devices. A reference data system can receive from a sample of devices confirmation of various characteristics.

Advantageously, the content provider system and reference data system can communicate their respective datasets while satisfying one or more privacy metrics (e.g., a differential privacy metric) on the communications. For instance, the content provider system and the reference data system can cooperatively estimate a confusion matrix for evaluating the overall performance of the predictions of the content provider system.

In general, a system can be associated with sets of client devices, for example by maintaining a client tag value that is associated with the respective client device. Each client tag value can correspond to attribute information that describes the association between a content server and client device. Attribute information can include information about the relationship between the client device and the content server (e.g., web-browsing history, interaction data, session time, network analysis data), and can include protected or otherwise private information received from the respective client device.

This traditional approach can be suboptimal. For example, this raw shared information can include protected or private information. Sharing this raw information can lead to decreased privacy. Further, such communications between the content servers and the centralized server can involve network communications that provide increased numbers of attack vectors for security breaches.

Further, the transmission of all client attribute data poses issues to scalability. As the number of client tag value servers increases, the amount of client device attribute data transmitted via the network typically increases as well. Because the attribute data can be detailed and relatively large for each client device, transmitting such information at scale can exhaust network bandwidth and computational resources.

Advantageously, according to example implementations of the present disclosure, a prediction system (e.g., a content provider system, a tag value server, etc.) can generate a sketch that compiles predicted characteristics for the served content events. The sketch can be indexed by, for instance, a tag value. The sketch can be noised or otherwise obscured. The noised sketch can satisfy a differential privacy criterion. The noised sketch can be transmitted to the reference data system.

A reference data system can use its confirmed reference characteristic data to evaluate the noised sketch. For instance, the reference data system can leverage the sketch index (e.g., the mapping function) to retrieve the predicted data for a given tag value. For the given tag value, the reference data system can compare its confirmed characteristic data. In this manner, for instance, the reference data system can generate a confusion matrix for the predictions of the content provider system.

The confusion matrix can be returned to the content provider system. The confusion matrix can be used to, for instance, correct errors in the aggregated metrics of the predictions of the content provider system. In this manner, for instance, the content provider system can learn to better predict characteristics for serving content.

An example confusion matrix can reflect classification accuracy of a prediction system. In general, if a pool of objects exists where each object can be classified into several categories, a goal can be to estimate the number of objects in each class. For this purpose, a prediction system can predict the category of each object. This prediction can have limited precision. To adjust the prediction error, a reference system can collect the true categories of a (small) subset of objects. The predictions and ground truths can be joined to obtain a confusion matrix, of which the (i, j)-th element is the count of objects that have a predicted category corresponding to i and a true category corresponding to j.

Using a binary classifier as an example, a confusion matrix can be described in terms of false and true positives and negatives.

| | Predicted bucket = “1” | Predicted bucket = “0” |
|---|---|---|
| True bucket = “1” | True Positive | False Negative |
| True bucket = “0” | False Positive | True Negative |

In general, an example confusion matrix for a two-class classifier can be represented as follows:

| | Predicted bucket = “A” | Predicted bucket = “B” |
|---|---|---|
| True bucket = “A” | # of “A” objects | # of “A” objects |
| | correctly classified into | incorrectly classified into |
| | bucket “A” | bucket “B” |
| True bucket = “B” | # of “B” objects | # of “B” objects |
| | incorrectly classified into | correctly classified into |
| | bucket “A” | bucket “B” |

With arbitrary numbers for an example, an example confusion matrix for a two-class classifier that processed a population of 2000 objects can be represented as follows:

| | Predicted bucket = “A” | Predicted bucket = “B” |
|---|---|---|
| True bucket = “A” | 800 | 300 |
| True bucket = “B” | 200 | 700 |

Normalizing the columns of the confusion matrix can provide a redistribution matrix. A redistribution matrix can be represented as follows:

| | Predicted bucket = “A” | Predicted bucket = “B” |
|---|---|---|
| True bucket = “A” | 0.8 | 0.3 |
| True bucket = “B” | 0.2 | 0.7 |

For instance, each cell of the redistribution matrix can be a conditional probability. For example, a value of 0.8 can be a probability of an object actually belonging to bucket “A” if the predicted bucket is “A”. Similarly, a value of 0.3 can be a probability of an object actually belonging to bucket “A” if the predicted bucket is “B”.

This probability can then be used to infer population-level statistics. For example, in some scenarios it can be estimated that the confusion matrix is generated over a representative sample. If a set of predictions over a population of objects resulted in 3000 predictions classified into bucket “A,” and 7000 predictions into bucket “B,” then it can be estimated that 80% of the “A” predictions are true “A” objects and 30% of the “B” predictions are true “B” objects, for a total of 4500 estimated true “A” objects. Using matrix multiplication,

$$[ \begin{matrix}0.8 & 0.3 \\ 0.3 & 0.7\end{matrix} ] [ \begin{matrix}3000 \\ 7000\end{matrix} ] = [ \begin{matrix}4500 \\ 5500\end{matrix} ] \begin{matrix}true {}^{″} {A}^{″} est . \\ true {}^{″} {B}^{″} est .\end{matrix}$$

In this manner, for instance, a confusion matrix can be used to better predict classifications of objects in the absence of ground truth signals. The confusion matrix can be used to determine trends in errors over a subset of objects or devices and apply the knowledge of the errors to better estimate performance over larger sets.

Example implementations can thereby facilitate cross-platform, cross-system evaluation of predictions. For instance, a reference data system can maintain a set of reference data that can be used to generate a confusion matrix or redistribution matrix over predictions from multiple prediction systems. For instance, confusion matrices estimated for each system can be combined together (e.g., added) to obtain an overall, cross-platform confusion matrix. In this manner, for instance, the reference system can securely generate performance data over multiple systems.

Advantageously, example implementations of the present disclosure provide for privacy-preserving techniques for estimating the confusion matrix for a set of predictions using a local set of ground truth data. In this manner, for instance, implementations of the present disclosure can leverage collective knowledge across a prediction system and a reference system without leaking user-level information.

Example implementations of the present disclosure can provide a number of technical effects and benefits. Example implementations can enable new distributed computing architectures that can train and deploy machine-learned models across different devices and systems without requiring distribution of potentially sensitive ground-truth training data. For example, actual ground-truth data can be maintained securely on a reference data system. The reference data system can generate estimated confusion matrices for predictions from a prediction system based on the local ground truth or reference data. These estimated confusion matrices can be used for evaluation of a performance of the prediction system without revealing to the prediction system the actual ground truth data.

Example implementations can provide for improved data security in networked transmissions. Example implementations can provide for locally implementing noising mechanisms that obscure sensitive data before data is transmitted, e.g., between a content provider system and a ground-truth panel operator. In this manner, the operation of networked computing systems can be improved, as well as enabling distributed and multi-party computation. For instance, where some prior systems might only be able to operate locally, implementations of the present disclosure can facilitate training of and deployment of machine-learned models across different devices and systems without requiring distribution of potentially sensitive ground-truth training data across those different devices and systems. Thus, example implementations can advance the field of distributed and multi-party computation as a whole, especially in the areas of privacy and data security.

Example implementations can provide for computing the intersections, unions, and attribute frequencies can address both the scale of the problem and stringent privacy requirements through the use of data sketch structures (e.g., bloom filters) for frequency and reach estimations. Since the number of computational devices and the number of communications which the techniques of the present disclosure may be applied to can be very large, the improvements to the efficiency of processing and the security of user data enabled by the techniques of the present disclosure can be particularly significant. Such systems and methods of aspects of this present solution can be performed, executed, or otherwise operated by different entities without concern that any set of entities would breach the private or protected information of the other parties involved.

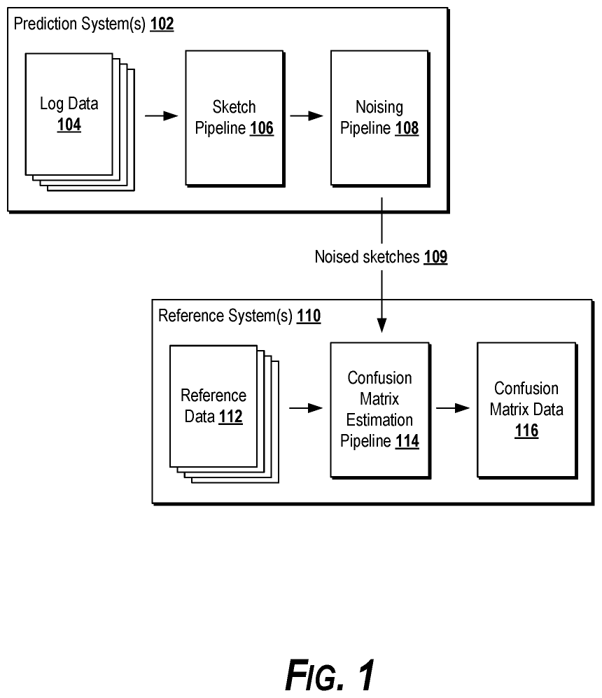

FIG. 1 is a block diagram of an example distributed computation system according to example aspects of the present disclosure. A prediction system 102 can store log data 104. Log data 104 can include event data objects with corresponding predicted values associated therewith. Prediction system 102 can implement a sketch pipeline 106 to generate a sketch of one or more event data objects and the one or more predicted values corresponding thereto. Prediction system 102 can implement a noising pipeline 108 to add noise to sketches generated by sketch pipeline 106.

The noised sketches 109 can be transmitted to a reference system 110. Reference system 110 can store reference data 112. Reference data 112 can include event data objects with corresponding reference values associated therewith. Reference data 112 can include a subset of event data objects that are in log data 104. Reference system 110 can implement a confusion matrix estimation pipeline 114 that estimates a confusion matrix for a noised sketch generated by noising pipeline 108 based on reference data 112. Confusion matrix estimation pipeline 114 can generate confusion matrix data 116.

Prediction system(s) 102 can include one or more computing devices or systems that generate predictions based on input data. Prediction system 102 can generate various different kinds of predictions. Prediction system 102 can generate predictions that characterize future activity of prediction system 102 (e.g., to determine what operations prediction system 102 should perform), that characterize past activity (e.g., to retrospectively evaluate a performance of prediction system 102 for improving an operation of prediction system 102), etc.

Prediction system 102 can generate predictions using one or more prediction models. A prediction model can be or include one or multiple machine-learned models. The prediction model can operate locally on prediction system 102. Local operation can reduce a latency of prediction. Local operation can reduce an amount of data to be transmitted over a network. For instance, if a prediction model is implemented on a centralized server, then inputs can be transmitted over a network to the server and outputs can be transmitted over a network from the server. In contrast, local deployment of a prediction model within an operational environment that already has access to the inputs can facilitate direct processing of the inputs and avoid some amount of additional network traffic. Advantageously, example implementations of the present disclosure can facilitate local operation of prediction models while allowing the prediction models to be evaluated with respect to data distributed over multiple systems without directly distributing the data itself.

An example prediction system can operate in association with a content provider system. A content provider system can include a content distribution system that serves content to a plurality of client devices. For example, a content distribution system can serve content in response to requests for content. The requests for content can originate from a client device or another device that is preparing content for delivery to the client device. For example, primary content (e.g., a web page) can include executable instructions that, when loaded and executed by a client device or other device, initiate a request for additional content (e.g., supplemental content, such as content suggesting or linking to other networked resources).

An example prediction system can predict attributes of devices that request or receive content. Such attributes can include the type of device, the operating system of the device, the geographic location of the device, the network connectivity of the device, the time of day the device is most active, an activity history of the device, attributes of a user account associated with the device, etc. These attributes can be useful in understanding usage patterns of the devices and in tailoring the content that is served to the devices.

For instance, if a device is identified as a mobile device and is most active during commuting hours, the content provider system can predict that the user of the device is likely to be commuting during these times and can serve relevant content accordingly. Similarly, if a device is identified as being located in a particular geographic region, the content provider system can serve content that is relevant to that region.

A device type attribute can indicate whether the device is a smartphone, a tablet, a desktop computer, a smart TV, or any other type of device capable of requesting or receiving content. Knowing the device type can help tailor the content appropriately, as the format or type of content that is optimal can vary significantly between different device types.

A user account attribute can indicate information about a user account associated with a device. The user account can be a local account (e.g., unique to the device) or an account with an internet services provider (e.g., a platform that provides content or services using an internet server). An example prediction system can predict various attributes of the user account. An example user account attribute can include a classification of the user account into a group or category (e.g., a cluster of user accounts with similar feature(s)). An example classification can include a class or category collecting accounts that are associated with a feature. For example, an example classification can include classifying a device into a category collecting user accounts that are associated with the topic of gardening. A given device can be classified into multiple categories if the prediction system predicts that a device can be associated with multiple features (e.g., associated with multiple topics). The features can be descriptive of content accessed in association with the user account (e.g., content relating to various topics). The features can be descriptive of utilization patterns of a device itself (e.g., touchscreen utilization, audio interface utilization, etc.). In general, user account attributes can include indicators of various different kinds of features.

Example attributes can include, for example, client device location data, client device metadata, client device parameters, settings, and other information, user profile data, interactions performed by the client device, application browsing history, web page browsing history, activity information, device characteristics, whether the client device has viewed or interacted with a particular item of content, whether a client device has performed a particular online activity, network utilization information, power utilization information, and device operating system version, settings, and other information, among others.

Log data 104 can include data describing events processed by prediction system 102 and corresponding predictions generated for the events. For instance, log data 104 can include event data objects describing one or more characteristics of a content request or content delivered to a client device. Log data 104 can include any predicted values generated based on the event data object or the characteristics described by the event data object. The predicted values can include, for instance, outputs of a prediction model as described herein.

Log data 104 can include data within a secured or permissioned boundary. For instance, prediction system 102 can receive data indicating a grant of permission for prediction system 102 to access, store, and use data describing content service events (e.g., requests, content served). The permission can be associated with a limited scope of access, storage, and use. For instance, the permission can restrict sharing of the data describing content service events.

Log data 104 can store the event data objects in association with the predicted values. For instance, a data store can include data records that associate event data objects with corresponding predictions. Log data 104 can index event data objects using tag values. A tag value can be a device identifier value. A tag value can be based on a user account identifier, such as a hashed username, email address, or other account name. A tag value can be randomly assigned. A tag value can be a secure passkey.

Log data 104 can include, for example, a data table as follows:

| Tag | Prediction |
|---|---|
| Value | Value |
| x₁ | B |
| x₂ | A |
| x₃ | B |
| . . . | . . . |
| x_{N} | y_{N} |

Sketch pipeline 106 can include one or more data mapping tools to generate a privatized representation of log data 104, or data “sketch,” that obscures the original data describing content service events. The term “sketch” can refer to one or more data structures containing one or more data elements, data records, variables, counter registers, floating point values, strings, index values, memory pointer values, or any combination thereof as described herein. The term “sketch” and “data structure” may sometimes be used interchangeably.

An example data sketch is a count-based sketch. A count-based sketch can use hash functions to index data into an array. For instance, a tag value can be hashed to generate a pointer to a position in an array. The position of the array can be incremented to indicate an occurrence of an event associated with that data object. The value in the position of the array can provide an estimate of a number of times the event has occurred. When a number of positions is at least the same as a number of data objects, the value can provide an exact indicator. When a number of positions is less than the number of objects, multiple different events can be mapped to the same position, introducing some approximation error. When low-likelihood events collide with high-likelihood events, the value can remain an effective estimator of the frequency of the high-likelihood events. This sketch can be used to estimate a frequency of different elements in a data set or stream.

An example data sketch is a bloom filter. A bloom filter can use hash functions to activate bits of an array based on a hashed value of an input. For instance, a tag value can be hashed. The hashed value can be used to identify (e.g., point to) one or more positions in an array. These positions can be activated to represent an occurrence of an event associated with the tag value. The array can be queried to determine whether an event associated with a query tag value has been recorded in the array. The array can be queried by processing the query tag value using the hash functions. If any position in the array that is identified by the hashed result is zero, then it can be determined that the array does not record the occurrence of an event associated with the query tag value. If all positions in the array that are identified by the hashed value are not zero, then it can be determined that the array might have recorded occurrence of an event associated with the query tag value.

An example data sketch is a HyperLogLog sketch. HyperLogLog is often used in big data analytics to estimate the number of distinct elements.

Sketch pipeline 106 can generate a plurality of sketches for a plurality of different classification values. For example, an event associated with a data object can be a classification event. A classification event can be a prediction that a given event data object is associated with a particular classification value. A given data sketch can be a representation of which event data objects are associated with that particular classification value.

For example, prediction system 102 can use a function that maps a tag value in log data to a position in a vector of counts. An example mapping can be represented by

h: x [symbol] A bucket in {1, . . . ,M}

where M is chosen to be large enough, and h is chosen to be uniform enough, such that there barely exist two tag values x₁ ≠x₂ such that h(x₁)=h(x₂). Practically, h(x)=hash (x) mod M can be chosen for a uniform hash such as the fingerprint2011 hashing function.

In an example, for each prediction class d, prediction system 102 can generate an array v^{d}, a vector of zeros with length M. For each event data object in the log data, prediction system 102 can obtain a tag value. Prediction system 102 can determine the predicted value associated with the event data object. In the array v^{d} corresponding to the predicted value d, prediction system 102 can increment a position in v^{d} that corresponds to the tag value x. For instance, v^{d} [h(x)]+=1.

As an example, suppose a log has 9 events (e.g., views or impressions of distributed content): 4 impressions on tag value 1, 3 impressions on tag value 2, and 2 impressions on tag value 3. Suppose that the prediction values for tag value 1 and tag value 3 are predicted as “A”, and tag value 2 is predicted as “B”. Suppose a mapping h into M=4 positions, under which h(x₁)=1, h(x₂)=2, h(x₃)=4. Prediction system 102 can retrieve two v^{d}s that correspond to “A” and “B” respectively and increment the appropriate positions to generate the following two sketches:

v^{“A”}=[4,0,0,2]

v^{“B”}=[0,3,0,0].

In another example, these sketches can be expanded into multiple binary vectors. For instance, each sketch can be expanded into a binary vector per frequency level. For example, consider v^{d}=[4, 1, 0, 2] which indicates that the tag value mapped to position 1 has 4 events, the tag value mapped to position 2 has 1 events, the tag value mapped to position 3 has 0 events (or there's no tag value mapped to position 3), the tag value mapped to position 4 has 2 events. In an example, this v^{d} can be expanded into 5 binary vectors.

A 0—event vector

v^{d,0}=[0,0,1,0]

can indicate that there is a tag value mapped to position three with 0 events (or there is no tag value mapped to position 3, resulting in 0 recorded events).

A 1—event vector

v^{d,1}=[0,1,0,0]

can indicate that there is a tag value mapped to position 2 with 1 recorded event.
A 2—event vector

v^{d,2}=[0,0,0,1]

can indicate that there is a tag value mapped to position 4 with 2 recorded events.

A 3—event vector

v^{d,3}=[0, 0, 0, 0]

can indicate that there are no tag values mapped to any position with 3 recorded events.

A 4—event vector

v^{d,4}=[1,0,0,0]

can indicate that there is a tag value mapped to position 1 with 4 recorded events.

In this manner, for example, for each prediction value d, the prediction system can expand v^{d} into v^{d,0}, v^{d,1}, . . . , v^{d,F} where F is a cap on a maximum frequency of events per tag value.

Sketch pipeline 106 can generate data sketches and pass the generated sketches to a noising pipeline 108.

Noising pipeline 108 can add noise to or otherwise transform sketches generated by sketch pipeline 106 to satisfy one or more privacy or security criteria. For example, various types of noise can be added to the sketches. Laplace noise can be added to the sketches. Gaussian noise can be added to the sketches.

Noise can be added to the sketches until a differential privacy criterion is satisfied. The term “differential privacy” (DP) can refer to sharing information about a dataset by describing the patterns of groups within the dataset while limiting information about individuals leaking through the sharing of the dataset. DP can be a constraint on the algorithms used to publish aggregate information about a statistical database which limits the disclosure of private information of records whose information is in the database. For instance, a DP constraint for an aggregate dataset can be satisfied when the presence of any given user's information does not shift the dataset beyond a privacy value ∈ (referred to as “∈-DP”). In some implementations, DP can be achieved by adding noise to the dataset.

In an example, to provide e-DP of all v^{d}s, prediction system 102 can independently add Laplace noise, with scale parameter 1/∈, to each element of each v^{d}

In an example that uses the binary vector expansion, another noising mechanism can include randomly performing bitflips in the vectors with a probability p. Bit-flipping with probability p can provide e-DP with

$$ϵ = ln ( \frac{1 - p}{p} ) .$$

Prediction system 102 can share noised sketches 109 with reference system 110. Noised sketches 109 can be obscured by the noise such that no private data leaks from a secured or permissioned boundary of prediction system 102.

Reference system(s) 110 can be or include one or more computing devices or systems that evaluate noised sketches 109. Reference system(s) 110 can include a trusted third party system with which prediction system(s) 102 has a secured and permissioned communication channel. Reference system 110 can process noised sketches 109 to evaluate a performance of predictions described thereby.

Reference system 110 can be associated with a ground truth panel operator. A panel operator can include a system that engages with client devices to obtain permissioned access to attributes associated with the client devices and user accounts associated therewith. For example, users can voluntarily participate in a panel in exchange for a desired perk or reward. A panel of client devices can facilitate insight into content accessed by the devices that is indexed with attributes associated with the devices and user accounts associated therewith. In this manner, for example, reference system 110 can collect reference data 112 that can serve as ground truth for predictions regarding attributes associated with the devices and user accounts associated therewith.

Reference data 112 can include known or ground truth attribute data that can be used as a point of reference for evaluating noised sketches 109. Reference data 112 can include data similar to log data 104. Reference data 112 can include a data table for one or more panels. Reference data 112 can include other ground truth attribute data obtained from sources other than panels.

Reference data 112 can include a data table as follows:

| | Reference |
|---|---|
| Tag | Attribute |
| Value | Value |
| x₂ | B |
| x₄ | A |
| . . . | . . . |
| x_{P} | y_{P} |

Tag values in reference data 112 can overlap with log data 104. Tag values in reference data 112 can be a proper subset of tag values in log data 104. Tag values in reference data 112 can include other tag values not present in log data 104.

Confusion matrix estimation pipeline 114 can generate confusion matrix data 116 from noised sketches 109 and reference data 112. Confusion matrix estimation pipeline 114 can include features of sketch pipeline 106. For instance, confusion matrix estimation pipeline 114 can include the mapping used by sketch pipeline 106 to populate sketch values based on log data 104. For example, a sketch pipeline 106 can use a mapping function h, and prediction system 102 can share h with reference system 110 to use in confusion matrix estimation pipeline 114.

Confusion matrix estimation pipeline 114 can implement all or part of sketch pipeline 106 to map tag values in reference data 112 to positions in an array (e.g., as if generating a sketch of reference data 112).

Confusion matrix estimation pipeline 114 can estimate the (g, d)-th cell of a confusion matrix for any true class g and predicted class d. In an example, confusion matrix estimation pipeline 114 can determine tag values in reference data 112 that all have true class g. Confusion matrix estimation pipeline 114 can find the positions in the array to which those tag values are mapped. Confusion matrix estimation pipeline 114 can find I^{g}={h(x): x in ref. data, x has true class g}.

Confusion matrix estimation pipeline 114 can select these positions of v^{d} and sum the values stored in those positions. For instance, confusion matrix estimation pipeline 114 can obtain the following sum:

$${\sum }_{i ∈ {I}^{g}} {v}^{d} [ i ] .$$

When v^{d} is unnoised, this sum can equal the (g, d)-th cell of the confusion matrix, such as the number of events associated with the tag values in reference data 112 that have true class g and predicted class d.

When v^{d} is noised, this sum can be an unbiased estimate of the (g, d)-th cell of the confusion matrix, such as the number of events associated with the tag values in reference data 112 that have true class g and predicted class d.

For a sketch pipeline 106 that expands v^{d} into multiple binary vectors, confusion matrix estimation pipeline 114 can estimate confusion matrix data as follows. For frequency f from 1 to maximum frequency F, confusion matrix estimation pipeline 114 can selects the positions of v^{df} corresponding to the tag values in reference data 112. Confusion matrix estimation pipeline 114 can count the number of ones and zeros. The number of ones can represent a noised number of positive predictions for a particular class at a particular frequency. The number of zeros can represent a noised number of negative predictions for a particular class at a particular frequency.

In an example with bitflip noise, if the bitflip probability p is known, the number of positive predictions can be scaled by a probability of no bitflip (q=1−p) to give a number of expected actual pre-noise predictions that survived the bitflip. The number of negative predictions can also be scaled by a probability of bitflip p to give a number of expected actual pre-noise predictions that were canceled by the bitflip. These scaled totals can be combined and rescaled to obtain a total number of expected actual pre-noise predictions \hat{n} for each ground truth class g, prediction class d, and frequency level f. Confusion matrix estimation pipeline 114 can obtain the sum

$${\hat{n}}^{g , d} = {\sum }_{f = 1}^{F} f \times {\hat{n}}^{g , d , f}$$

which can estimate the number of events associated with the tag values that have true class g and predicted class d—the (g, d)-th cell of confusion matrix.

In an example, to estimate a cell of the confusion matrix, the reference system estimates a count of tag values for each combination of true class, predicted class, and frequency level, and then computes a weighted sum of these counts.

In an example, confusion matrix estimation pipeline 114 can obtain

x^{g,d,f}={i∈I^{g}: v^{a,f}[i]=1}

and

z^{g,d,f}={i∈I^{g}: v^{d,f}[i]=0}.

Confusion matrix estimation pipeline 114 can then obtain

$${\hat{n}}^{g , d , f} = ( {qx}^{g , d , f} - {pz}^{g , d , f} ) / ( q - p )$$

where p is the flipping probability and q=1−p. This n^{g,d,f} can be an unbiased estimate of the number of tag values with true class g, inferred class d and frequency f.

Confusion matrix data 116 can include data for one or more cells of a confusion matrix. Confusion matrix data 116 can include a specified subset of cells of a confusion matrix.

As described above, reference system 110 can use confusion matrix data 116 to evaluate a performance of prediction system 102. Reference system 102 can generate a redistribution matrix using confusion matrix data 116. The redistribution matrix can be used to evaluate an amount of erroneous classifications to correct the predicted values. For example, reference system 110 can estimate a true distribution of predicted classes corresponding to noised sketches 109.

In some implementations, only prediction system 102 adds noise. Reference system 110 can omit adding noise. This can reduce the DP noise and improve the accuracy.

In some implementations, reference system 110 can add noise to confusion matrix data 116 for distribution of confusion matrix data 116. For instance, if another system also requests a confusion matrix to estimate a true distribution, reference system 110 can have another pipeline for noising the confusion matrix to achieve DP before sharing it (e.g., using additive Laplacian noise).

Reference system 110 can return an evaluation of the performance of prediction system 102. Reference system 110 can return a scoring or other quantitative evaluation. Reference system 110 can return a redistribution matrix. Reference system 110 can return an estimated distribution over predicted classes.

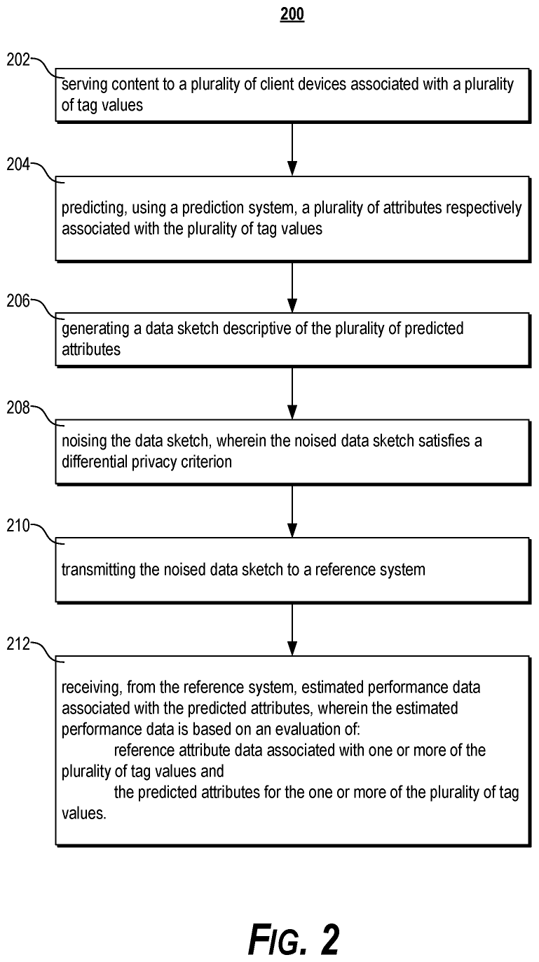

FIG. 2 depicts a flowchart of a method 200 for estimating performance data according to aspects of the present disclosure. One or more portion(s) of example method 200 can be implemented by a computing system that includes one or more computing devices such as, for example, computing systems described with reference to the other figures. Each respective portion of example method 200 can be performed by any (or any combination) of one or more computing devices. Moreover, one or more portion(s) of example method 200 can be implemented on the hardware components of the device(s) described herein. FIG. 2 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 2 is described with reference to elements/terms described with respect to other systems and figures for exemplary illustrated purposes and is not meant to be limiting. One or more portions of example method 200 can be performed additionally, or alternatively, by other systems.

At 202, example method 200 can include serving content to a plurality of client devices associated with a plurality of tag values. For example, a content provider system can include a content distribution system that serves content to a plurality of client devices. For example, a content distribution system can serve content in response to requests for content. The requests for content can originate from a client device or another device that is preparing content for delivery to the client device. For example, primary content (e.g., a web page) can include executable instructions that, when loaded and executed by a client device or other device, initiate a request for additional content (e.g., supplemental content, such as content suggesting or linking to other networked resources).

At 204, example method 200 can include predicting, using a prediction system, a plurality of attributes respectively associated with the plurality of tag values. An example prediction system (e.g., prediction system 102) can operate in association with a content provider system. An example prediction system can predict attributes of devices that request or receive content. Such attributes can include the type of device, the operating system of the device, the geographic location of the device, the network connectivity of the device, the time of day the device is most active, an activity history of the device, attributes of a user account associated with the device, etc. These attributes can be useful in understanding usage patterns of the devices and in tailoring the content that is served to the devices.

At 206, example method 200 can include generating a data sketch descriptive of the plurality of predicted attributes. For instance, a sketch pipeline 106 of a prediction system 102 can generate a data sketch of predictions in log data. For example, prediction system 102 can store data describing events processed by prediction system 102 and corresponding predictions generated for the events as log data (e.g., log data 104). For instance, log data 104 can include event data objects describing one or more characteristics of a content request or content delivered to a client device. Log data 104 can include any predicted values generated based on the event data object or the characteristics described by the event data object. The predicted values can include, for instance, outputs of a prediction model as described herein. Sketch pipeline 106 of prediction system 102 can include one or more data mapping tools to generate a privatized representation of log data 104, or data “sketch,” that obscures the original data describing content service events. The term “sketch” can refer to one or more data structures containing one or more data elements, data records, variables, counter registers, floating point values, strings, index values, memory pointer values, or any combination thereof as described herein. The term “sketch” and “data structure” may sometimes be used interchangeably.

At 208, example method 200 can include noising the data sketch, wherein the noised data sketch satisfies a differential privacy criterion. Noising pipeline 108 can add noise to or otherwise transform sketches generated by sketch pipeline 106 to satisfy one or more privacy or security criteria. For example, various types of noise can be added to the sketches. Laplace noise can be added to the sketches. Gaussian noise can be added to the sketches. Noise can be added to the sketches until a differential privacy criterion is satisfied. The term “differential privacy” (DP) can refer to sharing information about a dataset by describing the patterns of groups within the dataset while limiting information about individuals leaking through the sharing of the dataset. DP can be a constraint on the algorithms used to publish aggregate information about a statistical database which limits the disclosure of private information of records whose information is in the database. For instance, a DP constraint for an aggregate dataset can be satisfied when the presence of any given user's information does not shift the dataset beyond a privacy value E (referred to as “∈-DP”). In some implementations, DP can be achieved by adding noise to the dataset. In an example, to provide e-DP of all v^{d}s, prediction system 102 can independently add Laplace noise, with scale parameter 1/∈, to each element of each v^{d}.

At 210, example method 200 can include transmitting the noised data sketch to a reference system. The noised data sketch (e.g., noised data sketch 109) can be transmitted over a network to reference system 110.

At 212, example method 200 can include receiving, from the reference system, estimated performance data associated with the predicted attributes. In some implementations of example method 200, the estimated performance data is based on an evaluation of reference attribute data associated with one or more of the plurality of tag values and the predicted attributes for the one or more of the plurality of tag values. In some implementations of example method 200, the estimated performance data includes an updated distribution over the plurality of attributes. In some implementations of example method 200, the estimated performance data is based on a confusion matrix estimated by the reference system. For example, estimated performance data can include a confusion matrix or a redistribution matrix estimated as described herein.

In some implementations of example method 200, generating the data sketch includes, for each predicted attribute: hashing a tag value associated with the predicted attribute; indexing, based on the hashed tag value, an array of the data sketch to obtain a selected position; and incrementing a value in the selected position. In some implementations of example method 200, generating the data sketch includes generating a plurality of data sketches respectively corresponding to a plurality of different prediction classes. In some implementations of example method 200, the data sketch includes a count-based array.

As an example, suppose a log data record has 9 events (e.g., views or impressions of distributed content): 4 impressions on tag value 1, 3 impressions on tag value 2, and 2 impressions on tag value 3. Suppose that the predicted attribute values for tag value 1 and tag value 3 are predicted as “A”, and tag value 2 is predicted as “B”. Suppose a mapping h into M=4 positions, under which h(x₁)=1, h(x₂)=2, h(x₃)=4. Prediction system 102 can retrieve two v^{d}s that correspond to “A” and “B” respectively and increment the appropriate positions to generate the following two sketches:

v^{“A”}=[4,0,0,2]

v^{“B”}=[0,3,0,0].

In some implementations of example method 200, noising the data sketch includes injecting additive noise to elements of the data sketch. Laplace noise can be added to the sketches. Gaussian noise can be added to the sketches. Other random noise can be added to the sketches.

In some implementations of example method 200, generating the data sketch includes expanding an initial sketch vector into a binary representation. In some implementations of example method 200, expanding the initial sketch includes, for each respective predicted attribute, generating a binary vector for each frequency level, wherein the frequency level indicates a frequency with which a corresponding respective tag value is associated with the respective predicted attribute.

In an example, sketches can be expanded into multiple binary vectors. For instance, each sketch can be expanded into a binary vector per frequency level. For example, consider v^{d}=[4, 1, 0, 2] which indicates that the tag value mapped to position 1 has 4 events associated with prediction value d, the tag value mapped to position 2 has 1 event associated with prediction value d, the tag value mapped to position 3 has 0 events associated with prediction value d (or there's no tag value mapped to position 3), the tag value mapped to position 4 has 2 events associated with prediction value d. In an example, this v^{d} can be expanded into 5 binary vectors.

A 0—event vector

v^{d,0}=[0,0,1,0]

can indicate that there is a tag value mapped to position three with 0 events (or there is no tag value mapped to position 3, resulting in 0 recorded events).

A 1—event vector

v^{d,1}=[0,1,0,0]

can indicate that there is a tag value mapped to position 2 with 1 recorded event.

A 2—event vector

v^{d,2}=[0,0,0,1]

can indicate that there is a tag value mapped to position 4 with 2 recorded events.

A 3—event vector

v^{d,3}=[0, 0, 0, 0]

can indicate that there are no tag values mapped to any position with 3 recorded events.

A 4—event vector

v^{d,4}=[1,0,0,0]

can indicate that there is a tag value mapped to position 1 with 4 recorded events.

In this manner, for example, for each prediction value d, the prediction system can expand v^{d} into v^{d,0}, v^{d,1}, . . . , v^{d,F} where F is a cap on a maximum frequency of events per tag value.

In some implementations of example method 200, noising the data sketch includes randomly performing bitflips on elements of the data sketch. In an example, a noising mechanism can include randomly performing bitflips in the vectors with a probability p. Bit-flipping with probability p can provide e-DP with

$$ϵ = ln ( \frac{1 - p}{p} ) .$$

In some implementations of example method 200, the data sketch includes a bloom filter.

In some implementations of example method 200, the data sketch is generated with a mapping function, and wherein the reference system uses the mapping function to identify the predicted attributes associated with the one or more of the plurality of tag values. In an example, confusion matrix estimation pipeline 114 can generate confusion matrix data 116 from noised sketches 109 and reference data 112 using features of sketch pipeline 106 (e.g., such as a mapping function h). For instance, confusion matrix estimation pipeline 114 can include the mapping used by sketch pipeline 106 to populate sketch values based on log data 104. For example, a sketch pipeline 106 can use a mapping function h, and prediction system 102 can share h with reference system 110 to use in confusion matrix estimation pipeline 114.

In some implementations of example method 200, the reference system processes tag values corresponding to the reference attribute data using the mapping function to find target positions in the data sketch to which the tag values are mapped. For instance, confusion matrix estimation pipeline 114 can implement all or part of sketch pipeline 106 to map tag values in reference data 112 to positions in an array (e.g., as if generating a sketch of reference data 112).

Confusion matrix estimation pipeline 114 can estimate the (g, d)-th cell of a confusion matrix for any true class g and predicted class d. In an example, confusion matrix estimation pipeline 114 can determine tag values in reference data 112 that all have true class g. Confusion matrix estimation pipeline 114 can find the positions in the array to which those tag values are mapped. Confusion matrix estimation pipeline 114 can find I^{g}={h(x): x in ref. data, x has true class g}.

In some implementations of example method 200, the reference system sums values of the noised sketch stored in the target positions. For instance, confusion matrix estimation pipeline 114 can select these positions of v^{d} and sum the values stored in those positions. For instance, confusion matrix estimation pipeline 114 can obtain the following sum:

$${\sum }_{i ∈ {I}^{g}} {v}^{d} [ i ] .$$

In some implementations of example method 200, the sum of the values of the noised sketch stored in the target positions corresponds to a quantity of predictions having a true attribute determined by the reference attribute data and a predicted attribute determined by a prediction class with which the noised sketch is associated. For instance, when v& is unnoised, this sum can equal the (g, d)-th cell of the confusion matrix, such as the number of events associated with the tag values in reference data 112 that have true class g and predicted class d. When v^{d} is noised, this sum can be an unbiased estimate of the (g, d)-th cell of the confusion matrix, such as the number of events associated with the tag values in reference data 112 that have true class g and predicted class d.

In some implementations of example method 200, the reference system counts a number of ones in each respective binary vector of a plurality of binary vectors and scales each respective count value using a frequency associated with the respective binary vector. In some implementations of example method 200, the reference system adjusts a count of the number of ones based on a bitflip probability.

In an example, for a sketch pipeline 106 that expands v^{d} into multiple binary vectors, confusion matrix estimation pipeline 114 can estimate confusion matrix data as follows. For frequency f from 1 to maximum frequency F, confusion matrix estimation pipeline 114 can selects the positions of v^{d,f} corresponding to the tag values in reference data 112. Confusion matrix estimation pipeline 114 can count the number of ones and zeros. The number of ones can represent a noised number of positive predictions for a particular class at a particular frequency. The number of zeros can represent a noised number of negative predictions for a particular class at a particular frequency.

In an example with bitflip noise, if the bitflip probability p is known, the number of positive predictions can be scaled by a probability of no bitflip (q=1-p) to give a number of expected actual pre-noise predictions that survived the bitflip. The number of negative predictions can also be scaled by a probability of bitflip p to give a number of expected actual pre-noise predictions that were canceled by the bitflip. These scaled totals can be combined and rescaled to obtain a total number of expected actual pre-noise predictions \hat{n} for each ground truth class g, prediction class d, and frequency level f. Confusion matrix estimation pipeline 114 can obtain the sum

$${\hat{n}}^{g , d} = {\sum }_{f = 1}^{F} f \times {\hat{n}}^{g , d , f}$$

which can estimate the number of events associated with the tag values that have true class g and predicted class d—the (g, d)-th cell of confusion matrix.

In an example, to estimate a cell of the confusion matrix, the reference system estimates a count of tag values for each combination of true class, predicted class, and frequency level, and then computes a weighted sum of these counts.

In an example, confusion matrix estimation pipeline 114 can obtain

x^{g,d,f}={i∈I^{g}: v^{d,f}[i]=1}

and

z^{g,d,f}={i∈I^{g}: v^{d,f}[i]=0}.

Confusion matrix estimation pipeline 114 can then obtain

$${\hat{n}}^{g , d , f} = ( {qx}^{g , d , f} - {pz}^{g , d , f} ) / ( q - p )$$

where p is the flipping probability and q=1-p. This \hat{n}^{g,d,f} can be an unbiased estimate of the number of tag values with true class g, inferred class d and frequency f.

In some implementations of example method 200, the reference system generates an estimated confusion matrix descriptive of predictions across a plurality of prediction systems. For instance, example implementations can facilitate cross-platform, cross-system evaluation of predictions. For instance, a reference data system can maintain a set of reference data that can be used to generate a confusion matrix or redistribution matrix over predictions from multiple prediction systems. For instance, confusion matrices estimated for each system can be combined together (e.g., added) to obtain an overall, cross-platform confusion matrix. In this manner, for instance, the reference system can securely generate performance data over multiple systems.

In some implementations of example method 200, the reference system has access to ground truth tag value data for associating reference attribute data with the one or more of the plurality of tag values. For example, reference system 110 can be associated with a ground truth panel operator. A panel operator can include a system that engages with client devices to obtain permissioned access to attributes associated with the client devices and user accounts associated therewith. For example, users can voluntarily participate in a panel in exchange for a desired perk or reward. A panel of client devices can facilitate insight into content accessed by the devices that is indexed with attributes associated with the devices and user accounts associated therewith. In this manner, for example, reference system 110 can collect reference data 112 that can serve as ground truth for predictions regarding attributes associated with the devices and user accounts associated therewith.

Reference data 112 can include known or ground truth attribute data that can be used as a point of reference for evaluating noised sketches 109. Reference data 112 can include data similar to log data 104. Reference data 112 can include a data table for one or more panels. Reference data 112 can include other ground truth attribute data obtained from sources other than panels.

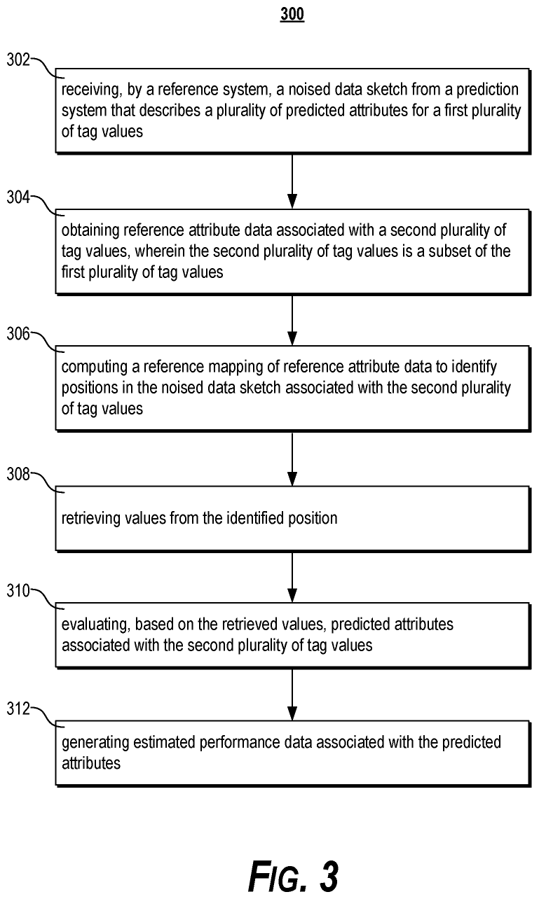

FIG. 3 depicts a flowchart of a method 300 for estimating performance data according to aspects of the present disclosure. One or more portion(s) of example method 300 can be implemented by a computing system that includes one or more computing devices such as, for example, computing systems described with reference to the other figures. Each respective portion of example method 300 can be performed by any (or any combination) of one or more computing devices. Moreover, one or more portion(s) of example method 300 can be implemented on the hardware components of the device(s) described herein, for example, to train one or more systems or models. FIG. 3 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 3 is described with reference to elements/terms described with respect to other systems and figures for exemplary illustrated purposes and is not meant to be limiting. One or more portions of example method 300 can be performed additionally, or alternatively, by other systems.

At 302, example method 300 can include receiving, by a reference system, a noised data sketch from a prediction system that describes a plurality of predicted attributes for a first plurality of tag values. For example, reference system 110 can receive noised data sketch 109 from prediction system 102.

At 304, example method 300 can include obtaining reference attribute data associated with a second plurality of tag values. For example, reference system 110 can obtain reference data 112. Reference data 112 can include prediction values that provide reference attribute data associated with one or more tag values. In some implementations of example method 300, the second plurality of tag values is a subset of the first plurality of tag values. For instance, tag values in reference data 112 can overlap with log data 104. Tag values in reference data 112 can be a proper subset of tag values in log data 104. Tag values in reference data 112 can include other tag values not present in log data 104.

At 306, example method 300 can include computing a reference mapping of reference attribute data to identify positions in the noised data sketch associated with the second plurality of tag values. For example, reference system 110 can apply all or part of a sketch generation pipeline 106 (e.g., a mapping function h) to map reference data tag values to positions in the sketch array.

At 308, example method 300 can include retrieving values from the identified position. For example, reference system 110 can index an array using the identified positions to retrieve values from the array.

At 310, example method 300 can include evaluating, based on the retrieved values, predicted attributes associated with the second plurality of tag values. For example, reference system 110 can obtain a value that indicates an estimated number of predictions from a noised sketch that correspond to a true or reference prediction value. This can evaluate a correctness of the predictions from the prediction system.

At 312, example method 300 can include generating estimated performance data associated with the predicted attributes. In some implementations of example method 300, the estimated performance data includes an updated distribution over the plurality of attributes (e.g., an adjusted number of predictions for each attribute). In some implementations of example method 300, the estimated performance data is based on a confusion matrix estimated by the reference system (e.g., a redistribution matrix).

In some implementations of example method 300, example method 300 includes summing values of the noised sketch stored in the positions. In some implementations of example method 300, the sum of the values of the noised sketch stored in the positions corresponds to a quantity of predictions having a true attribute determined by the reference attribute data and a predicted attribute determined by a prediction class with which the noised sketch is associated.

In an example, confusion matrix estimation pipeline 114 can generate confusion matrix data 116 from noised sketches 109 and reference data 112 using features of sketch pipeline 106 (e.g., such as a mapping function h). For instance, confusion matrix estimation pipeline 114 can include the mapping used by sketch pipeline 106 to populate sketch values based on log data 104. For example, a sketch pipeline 106 can use a mapping function h, and prediction system 102 can share h with reference system 110 to use in confusion matrix estimation pipeline 114.

In some implementations of example method 300, the reference system processes tag values corresponding to the reference attribute data using the mapping function to find target positions in the data sketch to which the tag values are mapped. For instance, confusion matrix estimation pipeline 114 can implement all or part of sketch pipeline 106 to map tag values in reference data 112 to positions in an array (e.g., as if generating a sketch of reference data 112).

Confusion matrix estimation pipeline 114 can estimate the (g, d)-th cell of a confusion matrix for any true class g and predicted class d. In an example, confusion matrix estimation pipeline 114 can determine tag values in reference data 112 that all have true class g. Confusion matrix estimation pipeline 114 can find the positions in the array to which those tag values are mapped. Confusion matrix estimation pipeline 114 can find I^{g}={h(x): x in ref. data, x has true class g}.

In some implementations of example method 300, the reference system sums values of the noised sketch stored in the target positions. For instance, confusion matrix estimation pipeline 114 can select these positions of v^{d} and sum the values stored in those positions. For instance, confusion matrix estimation pipeline 114 can obtain the following sum:

$${\sum }_{i ∈ {I}^{g}} {v}^{d} [ i ] .$$

In some implementations of example method 300, the sum of the values of the noised sketch stored in the target positions corresponds to a quantity of predictions having a true attribute determined by the reference attribute data and a predicted attribute determined by a prediction class with which the noised sketch is associated. For instance, when v^{d} is unnoised, this sum can equal the (g, d)-th cell of the confusion matrix, such as the number of events associated with the tag values in reference data 112 that have true class g and predicted class d. When v^{d} is noised, this sum can be an unbiased estimate of the (g, d)-th cell of the confusion matrix, such as the number of events associated with the tag values in reference data 112 that have true class g and predicted class d.

In some implementations of example method 300, example method 300 includes counting a number of ones in each respective binary vector of a plurality of binary vectors. In some implementations of example method 300, example method 300 includes scaling each respective count value using a frequency associated with the respective binary vector. In some implementations of example method 300, example method 300 includes adjusting a count of the number of ones based on a bitflip probability.

In an example, for a sketch pipeline 106 that expands v^{d} into multiple binary vectors, confusion matrix estimation pipeline 114 can estimate confusion matrix data as follows. For frequency f from 1 to maximum frequency F, confusion matrix estimation pipeline 114 can selects the positions of v^{d,f} corresponding to the tag values in reference data 112. Confusion matrix estimation pipeline 114 can count the number of ones and zeros. The number of ones can represent a noised number of positive predictions for a particular class at a particular frequency. The number of zeros can represent a noised number of negative predictions for a particular class at a particular frequency.

In an example with bitflip noise, if the bitflip probability p is known, the number of positive predictions can be scaled by a probability of no bitflip (q=1−p) to give a number of expected actual pre-noise predictions that survived the bitflip. The number of negative predictions can also be scaled by a probability of bitflip p to give a number of expected actual pre-noise predictions that were canceled by the bitflip. These scaled totals can be combined and rescaled to obtain a total number of expected actual pre-noise predictions \hat{n} for each ground truth class g, prediction class d, and frequency level f. Confusion matrix estimation pipeline 114 can obtain the sum

$${\hat{n}}^{g , d} = {\sum }_{f = 1}^{F} f \times {\hat{n}}^{g , d , f}$$

which can estimate the number of events associated with the tag values that have true class g and predicted class d—the (g, d)-th cell of confusion matrix.

In an example, to estimate a cell of the confusion matrix, the reference system estimates a count of tag values for each combination of true class, predicted class, and frequency level, and then computes a weighted sum of these counts.

In an example, confusion matrix estimation pipeline 114 can obtain

x^{g,d,f}={i∈I^{g}: v^{d,f}[i]=1}

and

z^{g,d,f}={i∈I^{g}: v^{d,f}[i]=0}.

Confusion matrix estimation pipeline 114 can then obtain

$${\hat{n}}^{g , d , f} = ( {qx}^{g , d , f} - {pz}^{g , d , f} ) / ( q - p )$$

where p is the flipping probability and q=1−p. This \hat{n}^{g,d,f} can be an unbiased estimate of the number of tag values with true class g, inferred class d and frequency f.

In some implementations of example method 300, the reference system generates an estimated confusion matrix descriptive of predictions across a plurality of prediction systems. For instance, example implementations can facilitate cross-platform, cross-system evaluation of predictions. For instance, a reference data system can maintain a set of reference data that can be used to generate a confusion matrix or redistribution matrix over predictions from multiple prediction systems. For instance, confusion matrices estimated for each system can be combined together (e.g., added) to obtain an overall, cross-platform confusion matrix. In this manner, for instance, the reference system can securely generate performance data over multiple systems.

In some implementations of example method 300, the reference system has access to ground truth tag value data for associating reference attribute data with the one or more of the plurality of tag values. For example, reference system 110 can be associated with a ground truth panel operator. A panel operator can include a system that engages with client devices to obtain permissioned access to attributes associated with the client devices and user accounts associated therewith. For example, users can voluntarily participate in a panel in exchange for a desired perk or reward. A panel of client devices can facilitate insight into content accessed by the devices that is indexed with attributes associated with the devices and user accounts associated therewith. In this manner, for example, reference system 110 can collect reference data 112 that can serve as ground truth for predictions regarding attributes associated with the devices and user accounts associated therewith.

Reference data 112 can include known or ground truth attribute data that can be used as a point of reference for evaluating noised sketches 109. Reference data 112 can include data similar to log data 104. Reference data 112 can include a data table for one or more panels. Reference data 112 can include other ground truth attribute data obtained from sources other than panels.

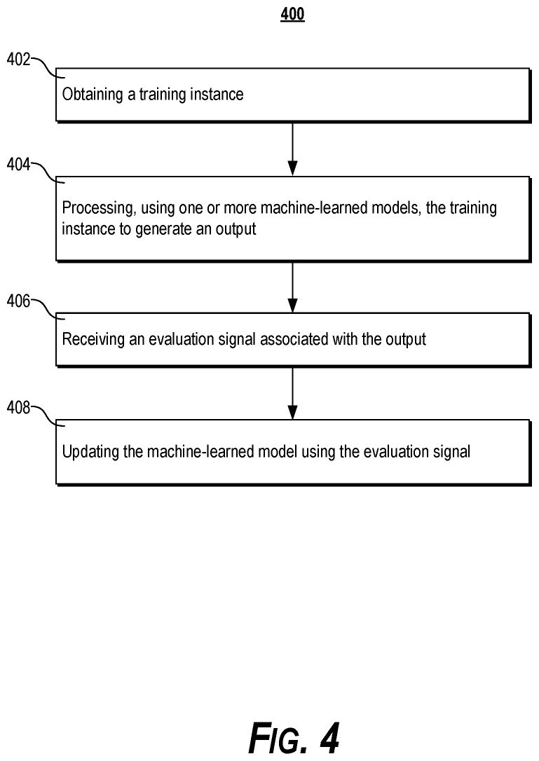

FIG. 4 depicts a flowchart of a method 400 for training one or more machine-learned models according to aspects of the present disclosure. For instance, an example machine-learned model can include a prediction model of prediction system 102.

One or more portion(s) of example method 400 can be implemented by a computing system that includes one or more computing devices such as, for example, computing systems described with reference to the other figures. Each respective portion of example method 400 can be performed by any (or any combination) of one or more computing devices. Moreover, one or more portion(s) of example method 400 can be implemented on the hardware components of the device(s) described herein, for example, to train one or more systems or models. FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 4 is described with reference to elements/terms described with respect to other systems and figures for exemplary illustrated purposes and is not meant to be limiting. One or more portions of example method 400 can be performed additionally, or alternatively, by other systems.

At 402, example method 400 can include obtaining a training instance. A set of training data can include a plurality of training instances divided between multiple datasets (e.g., a training dataset, a validation dataset, or testing dataset). A training instance can be labeled or unlabeled. Although referred to in example method 400 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

Example training instances can be contained in reference data 104.

At 404, example method 400 can include processing, using one or more machine-learned models, the training instance to generate an output. The output can be directly obtained from the one or more machine-learned models or can be a downstream result of a chain of processing operations that includes an output of the one or more machine-learned models.

Processing the training instance can include processing input data associated with a tag value in log data 104 that is associated with the training instance.

At 406, example method 400 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

The evaluation signal can correspond to or be based on performance data estimated by reference system 110. For instance, a reference system 110 can estimate a confusion matrix that can be used to estimate a true distribution over prediction classes over a population of predictions. This estimated true distribution can be used to evaluate the output distribution over prediction classes that is output by the prediction model.

At 408, example method 400 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 400 can include implementing a number of generalization techniques (e.g., weight decays, dropouts, etc.) to improve the generalization capability of the models being trained.

In some implementations, example method 400 can be implemented for training a machine-learned model from an initialized state to a fully trained state (e.g., when the model exhibits a desired performance profile, such as based on accuracy, precision, recall, etc.).

In some implementations, example method 400 can be implemented for particular stages of a training procedure. For instance, in some implementations, example method 400 can be implemented for pre-training a machine-learned model. Pre-training can include, for instance, large-scale training over potentially noisy data to achieve a broad base of performance levels across a variety of tasks/data types. In some implementations, example method 400 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

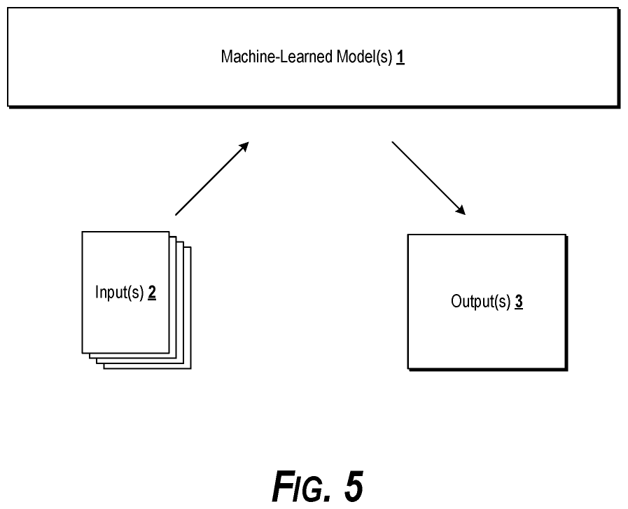

FIG. 5 is a block diagram of an example processing flow for using machine-learned model(s) 1 to process input(s) 2 to generate output(s) 3. Machine-learned model(s) 1 can be or include, for instance, a prediction model of prediction system 102.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a sequence processing model. Sequence processing model(s) can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see. e.g., Jumper et al., Highly accurate protein structure prediction with AlphaFold, 596 Nature 583 (Aug. 26, 2021), by way of example. Sequence processing model(s) can process one or multiple types of data simultaneously. Sequence processing model(s) can include relatively large models (e.g., more parameters, computationally expensive, etc.), relatively small models (e.g., fewer parameters, computationally lightweight, etc.), or both.

In general, sequence processing model(s) can obtain input sequence using data from input(s) 2. For instance, an input sequence can include a representation of data from input(s) 2 in a format understood by sequence processing model(s). One or more machine-learned components of sequence processing model(s) 4 can ingest the data from input(s) 2, parse the data into pieces compatible with the processing architectures of sequence processing model(s) (e.g., via “tokenization”), and project the pieces into an input space associated with one or more prediction layer(s) (e.g., via “embedding”).

Sequence processing model(s) can ingest the data from input(s) 2 and parse the data into a sequence of elements to obtain an input sequence. For example, a portion of input data from input(s) 2 can be broken down into pieces that collectively represent the content of the portion of the input data. The pieces can provide the elements of the sequence.

An output sequence of outputs 3 can have various relationships to the input sequence. An output sequence can be a continuation of an input sequence. An output sequence can be complementary to an input sequence. An output sequence can translate, transform, augment, or otherwise modify an input sequence. An output sequence can answer, evaluate, confirm, or otherwise respond to an input sequence. An output sequence can implement (or describe instructions for implementing) an instruction provided via an input sequence.

An output sequence can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, an output sequence can be autoregressively generated by sampling a likely next output element, adding that element to the context window, and re-generating the probability distribution based on the updated context window, and sampling a likely next output element, and so forth.

An output sequence can also be generated non-autoregressively. For instance, multiple output elements of an output sequence can be predicted together without explicit sequential conditioning on each other. See, e.g., Saharia et al., Non-Autoregressive Machine Translation with Latent Alignments, ARXIV: 2004.07437v3 (Nov. 16, 2020).

An output sequence can include one or multiple portions or elements. In an example content generation configuration, an output sequence can include multiple elements corresponding to multiple portions of a generated output sequence (e.g., a textual sentence, values of a discretized waveform, computer code, etc.). In an example classification configuration, an output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

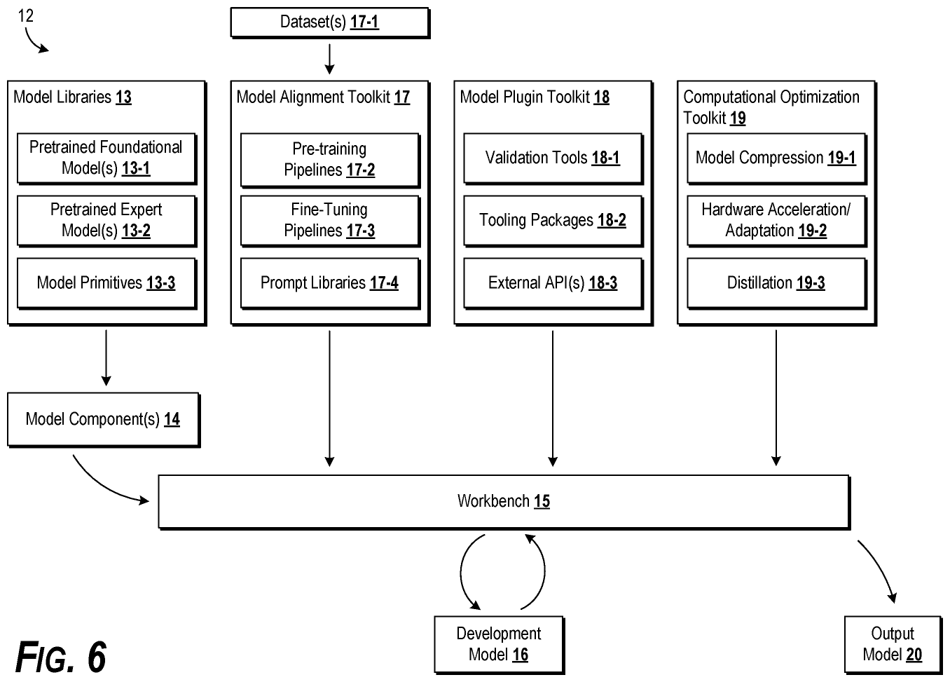

FIG. 6 is a block diagram of an example model development platform 12 that can facilitate creation, adaptation, and refinement of example machine-learned models (e.g., machine-learned model(s) 1, sequence processing model(s), etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 400 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

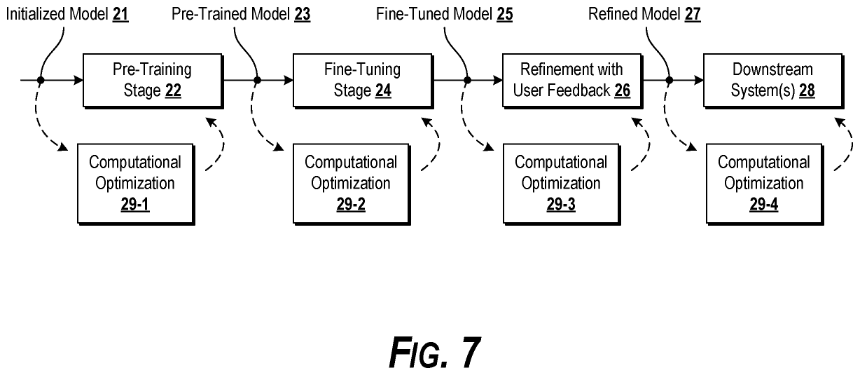

FIG. 7 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . 29-4 can all be the same, all be different, or include at least some different optimization techniques.

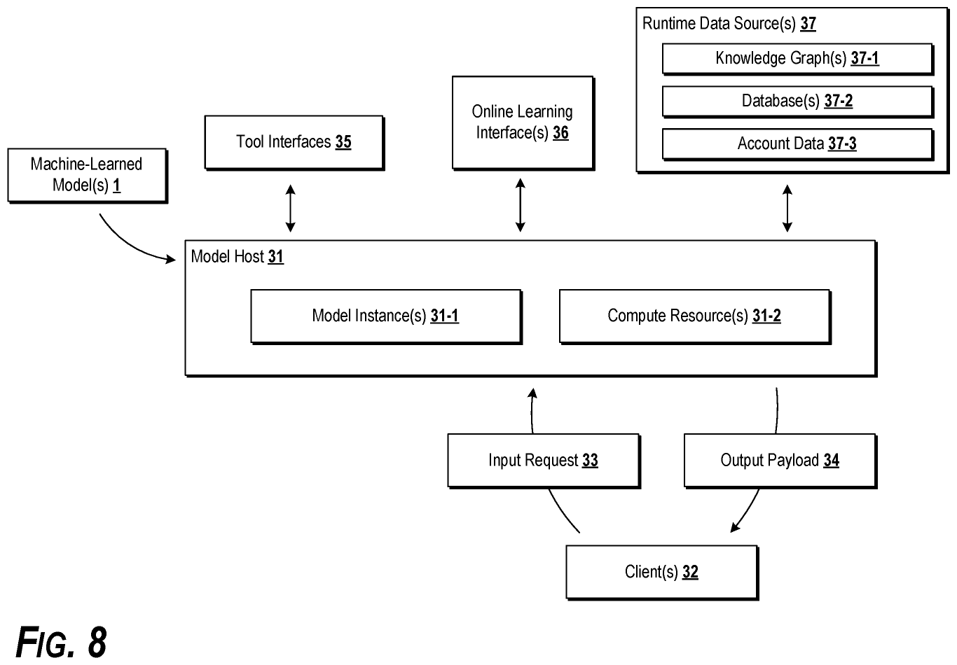

FIG. 8 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

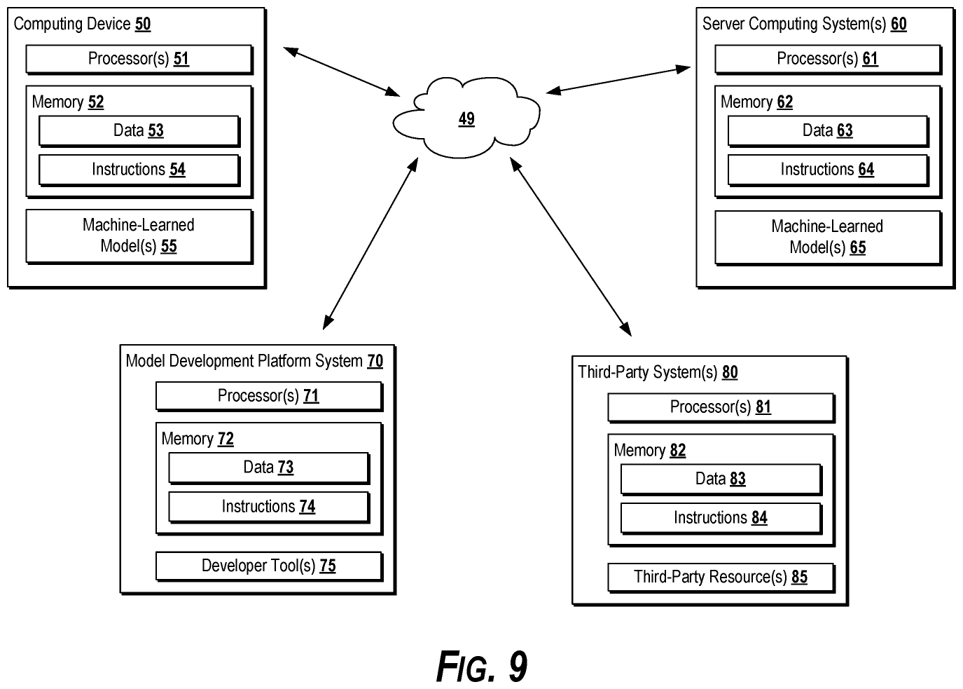

FIG. 9 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 9 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

Machine-learned model(s) 65 can include one or more prediction models. Server computing system(s) 60 can implement a prediction system 102. Server computing system(s) 60 can implement a reference system 110.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 16, 20, 55, 65, etc. (e.g., third-party resource(s) 85).

Third-party system(s) 80 can implement a reference system 110.

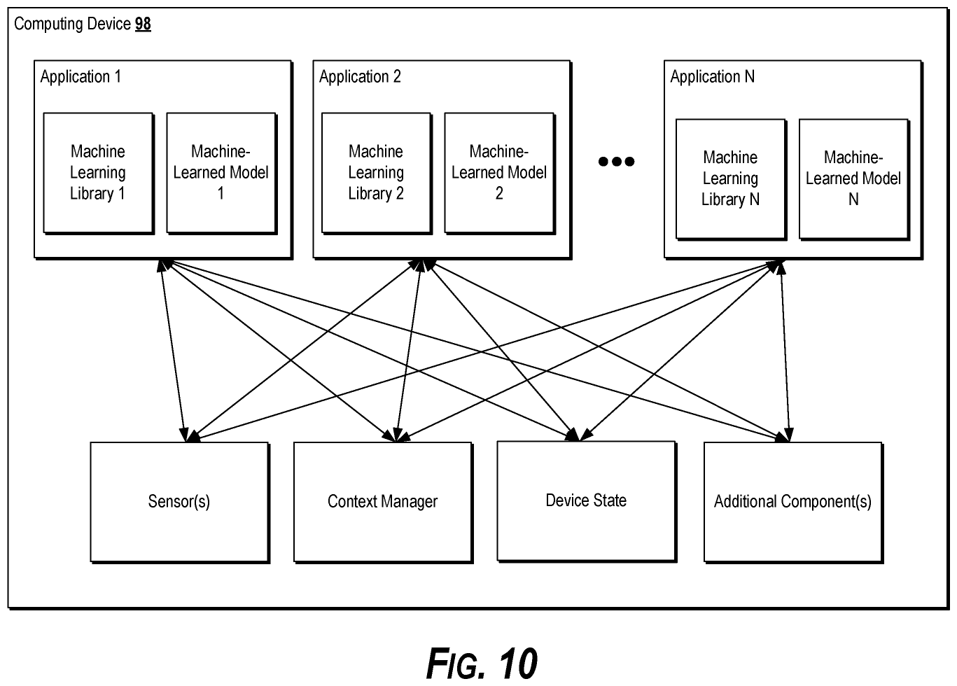

FIG. 10 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

FIG. 10 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 10, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

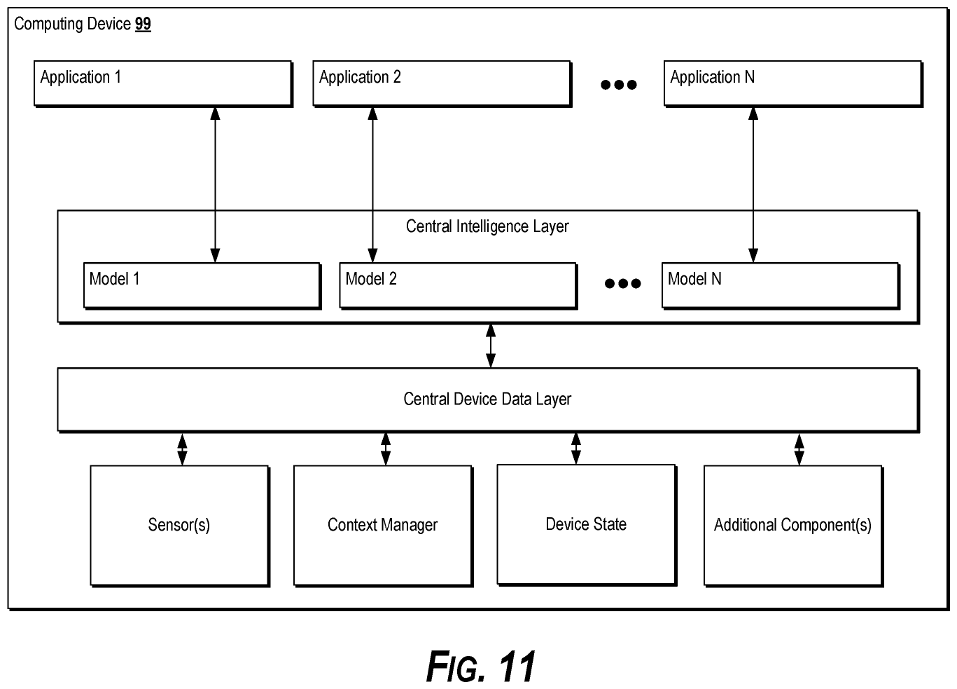

FIG. 11 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 11, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 11, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method comprising:
serving content to a plurality of client devices associated with a plurality of tag values;
predicting, using a prediction system, a plurality of attributes respectively associated with the plurality of tag values;
generating a data sketch descriptive of the plurality of predicted attributes;
noising the data sketch, wherein the noised data sketch satisfies a differential privacy criterion;
transmitting the noised data sketch to a reference system; and
receiving, from the reference system, estimated performance data associated with the predicted attributes, wherein the estimated performance data is based on an evaluation of:
reference attribute data associated with one or more of the plurality of tag values and
the predicted attributes for the one or more of the plurality of tag values.

2. The computer-implemented method of claim 1, wherein the estimated performance data comprises an updated distribution over the plurality of attributes.

3. The computer-implemented method of claim 1, wherein the estimated performance data is based on a confusion matrix estimated by the reference system.

4. The computer-implemented method of claim 1, wherein generating the data sketch comprises, for each predicted attribute:
hashing a tag value associated with the predicted attribute;
indexing, based on the hashed tag value, an array of the data sketch to obtain a selected position; and
incrementing a value in the selected position.

5. The computer-implemented method of claim 1, wherein generating the data sketch comprises generating a plurality of data sketches respectively corresponding to a plurality of different prediction classes.

6-7. (canceled)

8. The computer-implemented method of claim 1, wherein generating the data sketch comprises expanding an initial sketch vector into a binary representation, wherein expanding the initial sketch comprises, for each respective predicted attribute:
generating a binary vector for each frequency level, wherein the frequency level indicates a frequency with which a corresponding respective tag value is associated with the respective predicted attribute.

9. The computer-implemented method of claim 1, wherein noising the data sketch comprises:
randomly performing bitflips on elements of the data sketch.

10-11. (canceled)

12. The computer-implemented method of claim 1, wherein the data sketch is generated with a mapping function, and wherein the reference system uses the mapping function to identify the predicted attributes associated with the one or more of the plurality of tag values.

13. The computer-implemented method of claim 12, wherein the reference system processes tag values corresponding to the reference attribute data using the mapping function to find target positions in the data sketch to which the tag values are mapped.

14. The computer-implemented method of claim 13, wherein the reference system sums values of the noised data sketch stored in the target positions.

15. The computer-implemented method of claim 14, wherein the sum of the values of the noised data sketch stored in the target positions corresponds to a quantity of predictions having a true attribute determined by the reference attribute data and a predicted attribute determined by a prediction class with which the noised data sketch is associated.

16. The computer-implemented method of claim 9, wherein the reference system counts a number of ones in each respective binary vector of a plurality of binary vectors and scales each respective count value using a frequency associated with the respective binary vector.

17. The computer-implemented method of claim 16, wherein the reference system adjusts a count of the number of ones based on a bitflip probability.

18. A computer-implemented method, comprising:
receiving, by a reference system, a noised data sketch from a prediction system that describes a plurality of predicted attributes for a first plurality of tag values;
obtaining reference attribute data associated with a second plurality of tag values, wherein the second plurality of tag values is a subset of the first plurality of tag values;
computing a reference mapping of reference attribute data to identify positions in the noised data sketch associated with the second plurality of tag values;
retrieving values from the identified position;
evaluating, based on the retrieved values, predicted attributes associated with the second plurality of tag values; and
generating estimated performance data associated with the predicted attributes.

19. The computer-implemented method of claim 18, wherein the estimated performance data comprises an updated distribution over the plurality of predicted attributes.

20. The computer-implemented method of claim 18, wherein the estimated performance data is based on a confusion matrix estimated by the reference system.

21. The computer-implemented method of claim 18, comprising:
summing values of the noised data sketch stored in the positions.

22. The computer-implemented method of claim 21, wherein the sum of the values of the noised data sketch stored in the positions corresponds to a quantity of predictions having a true attribute determined by the reference attribute data and a predicted attribute determined by a prediction class with which the noised data sketch is associated.

23. The computer-implemented method of claim 18, comprising:
counting a number of ones in each respective binary vector of a plurality of binary vectors; and
scaling each respective count value using a frequency associated with the respective binary vector.

24. The computer-implemented method of claim 23, comprising:
adjusting a count of the number of ones based on a bitflip probability.

25-28. (canceled)
